(19) United States
(12) Patent Application Publication
(10) Pub. No.: US 2024/0172334 A1
(43) Pub. Date: May 23, 2024

(54) POSITIVE TEMPERATURE COEFFICIENT HEATER WITH EFFICIENT HEATING TRACES FOR FREEZE PROTECTION APPLICATIONS

(71) Applicant: Goodrich Corporation, Charlotte, NC (US)

(72) Inventors: Gururaja Bambila, Bangalore (IN); Harish Venkateshaiah, Bangalore (IN); Rhushikesh Patil, Bangalore (IN)

(21) Appl. No.: 18/156,839

(22) Filed: Jan. 19, 2023

(30) Foreign Application Priority Data
Nov. 23, 2022 (IN) 202211067346

(51) Int. Cl. H05B 3/34

(52) U.S. Cl. CPC H05B 3/34; H05B 2203/013; H05B 2203/017; H05B 2203/02

(57) ABSTRACT

The present disclosure provides for positive temperature coefficient (PTC) heater systems, assemblies and methods. More particularly, the present disclosure provides for PTC heater systems, assemblies and methods, with the PTC heaters having efficient heating traces for freeze protection applications (e.g., for aircraft/aerospace or the like). The present disclosure provides unique possibilities of heating patch nesting within heating areas for PTC heaters in order to achieve improved and/or efficient heating along with uniform power distribution. The PTC heater assemblies have a unique heater and/or heating pattern. The heating pattern of the patches of the heater assembly can be a combination/variety of shapes/designs, thereby ensuring that substantially each corner or the like of the heating area is printed with heater ink (PTC ink). Thus, the heater assembly efficiency is improved.

### CROSS-REFERENCE TO RELATED APPLICATIONS

This application claims the benefit of IN Application No. 202211067346 filed Nov. 23, 2022, the disclosure of which is incorporated herein by reference in its entirety.

### TECHNICAL FIELD

The present disclosure relates to positive temperature coefficient (PTC) heater systems, assemblies and methods and, more particularly, to PTC heater systems, assemblies and methods, with the PTC heaters having efficient heating traces for freeze protection applications (e.g., for aircraft/aerospace or the like).

### BACKGROUND

In general, positive temperature coefficient (PTC) inks and heaters developed using these inks are an emerging technology in freeze protection applications in/for aircraft. An advantage of a PTC heater can be the self-regulating characteristics of the heater so that the heater need not have an external device for controlling the temperature. The self-regulating feature can be basically achieved using a mixture of conductive particles (e.g., carbon black) within a polymer matrix. Exposing this to different temperatures can yield different resistances to current flow thus regulating the output power. This regulating character can be so precise that it can repeat many numbers of heating cycles.

### BRIEF DESCRIPTION

The present disclosure provides for PTC heater systems, assemblies and methods. More particularly, the present disclosure provides for PTC heater systems, assemblies and methods, with the PTC heaters having efficient heating traces for freeze protection applications (e.g., for aircraft/aerospace or the like).

The present disclosure provides for a positive temperature coefficient (PTC) heater assembly including a plurality of PTC ink patches printed on a base substrate; a conductive trace disposed on the base substrate, the conductive trace in communication with the plurality of PTC ink patches; and wherein the plurality of PTC ink patches includes at least one PTC ink patch that is non-square-shaped or non-rectangular-shaped.

In addition to one or more of the features described, or as an alternative to any of the foregoing embodiments, the plurality of PTC ink patches are printed from PTC ink.

In addition to one or more of the features described, or as an alternative to any of the foregoing embodiments, the base substrate is a thin and flexible substrate with a polymer base.

In addition to one or more of the features described, or as an alternative to any of the foregoing embodiments, the plurality of PTC ink patches includes two or more PTC ink patches that are non-square-shaped or non-rectangular-shaped.

In addition to one or more of the features described, or as an alternative to any of the foregoing embodiments, the at least one PTC ink patch that is non-square-shaped or non-rectangular-shaped has a shape selected from the group consisting of L-shaped, S-shaped, V-shaped, Z-shaped, U-shaped, C-shaped, M-shaped, N-shaped, oval-shaped, circular-shaped, curved-shaped, triangular-shaped, trapezoidal-shaped, parallel-pillar-shaped arrangement, trapezoidal-shaped with loop arrangement, square-shaped with loop arrangement, S-shaped loop arrangement, random-shape arrangement and tapered-shaped.

In addition to one or more of the features described, or as an alternative to any of the foregoing embodiments, each PTC ink patch of the plurality of PTC ink patches is configured to operate as a mini-heater.

In addition to one or more of the features described, or as an alternative to any of the foregoing embodiments, the PTC heater assembly is a PTC heater assembly onboard an aircraft or aerospace vessel.

In addition to one or more of the features described, or as an alternative to any of the foregoing embodiments, the PTC heater assembly is a PTC heater assembly for freeze protection applications.

In addition to one or more of the features described, or as an alternative to any of the foregoing embodiments, the PTC heater assembly is a PTC heater assembly for a tank, pipe, vessel or a valve.

In addition to one or more of the features described, or as an alternative to any of the foregoing embodiments, the conductive trace includes a line and a return.

The present disclosure provides for a method for fabricating a positive temperature coefficient (PTC) heater including printing a plurality of PTC ink patches on a base substrate; disposing a conductive trace on the base substrate, the conductive trace in communication with the plurality of PTC ink patches; and wherein the plurality of PTC ink patches includes at least one PTC ink patch that is non-square-shaped or non-rectangular-shaped.

In addition to one or more of the features described, or as an alternative to any of the foregoing embodiments, the plurality of PTC ink patches are printed from PTC ink.

In addition to one or more of the features described, or as an alternative to any of the foregoing embodiments, the base substrate is a thin and flexible substrate with a polymer base.

In addition to one or more of the features described, or as an alternative to any of the foregoing embodiments, the plurality of PTC ink patches includes two or more PTC ink patches that are non-square-shaped or non-rectangular-shaped.

In addition to one or more of the features described, or as an alternative to any of the foregoing embodiments, the at least one PTC ink patch that is non-square-shaped or non-rectangular-shaped has a shape selected from the group consisting of L-shaped, S-shaped, V-shaped, Z-shaped, U-shaped, C-shaped, M-shaped, N-shaped, oval-shaped, circular-shaped, curved-shaped, triangular-shaped, trapezoidal-shaped, parallel-pillar-shaped arrangement, trapezoidal-shaped with loop arrangement, square-shaped with loop arrangement, S-shaped loop arrangement, random-shape arrangement and tapered-shaped.

In addition to one or more of the features described, or as an alternative to any of the foregoing embodiments, further including operating each PTC ink patch of the plurality of PTC ink patches as a mini-heater.

In addition to one or more of the features described, or as an alternative to any of the foregoing embodiments, further including utilizing the PTC heater assembly onboard an aircraft or aerospace vessel.

In addition to one or more of the features described, or as an alternative to any of the foregoing embodiments, further including utilizing the PTC heater assembly for freeze protection applications.

In addition to one or more of the features described, or as an alternative to any of the foregoing embodiments, further including utilizing the PTC heater assembly to heat a tank, pipe, vessel or a valve.

In addition to one or more of the features described, or as an alternative to any of the foregoing embodiments, the conductive trace includes a line and a return.

The above described and other features are exemplified by the following figures and detailed description.

Any combination or permutation of embodiments is envisioned. Additional features, functions and applications of the disclosed systems, assemblies and methods of the present disclosure will be apparent from the description which follows, particularly when read in conjunction with the appended figures. All references listed in this disclosure are hereby incorporated by reference in their entireties.

### BRIEF DESCRIPTION OF THE DRAWINGS

The following figures are example embodiments wherein the like elements are numbered alike.

Features and aspects of embodiments are described below with reference to the accompanying drawings, in which elements are not necessarily depicted to scale.

Example embodiments of the present disclosure are further described with reference to the appended figures. It is to be noted that the various features, steps, and combinations of features/steps described below and illustrated in the figures can be arranged and organized differently to result in embodiments which are still within the scope of the present disclosure. To assist those of ordinary skill in the art in making and using the disclosed systems, assemblies and methods, reference is made to the appended figures, wherein:

FIG. 1 is a schematic of a positive temperature coefficient (PTC) heater assembly;

FIG. 2 is a schematic of an example positive temperature coefficient heater assembly, according to the present disclosure; and

FIG. 3 is a schematic of another example positive temperature coefficient heater assembly, according to the present disclosure.

### DETAILED DESCRIPTION

The example embodiments disclosed herein are illustrative of positive temperature coefficient heater systems, and assemblies of the present disclosure and methods/techniques thereof. It should be understood, however, that the disclosed embodiments are merely examples of the present disclosure, which may be embodied in various forms. Therefore, details disclosed herein with reference to example positive temperature coefficient heater systems and associated processes/techniques of fabrication/assembly and use are not to be interpreted as limiting, but merely as the basis for teaching one skilled in the art how to make and use the systems/assemblies and/or alternative systems/assemblies of the present disclosure.

The present disclosure provides for positive temperature coefficient (PTC) heater systems, assemblies and methods. More particularly, the present disclosure provides for PTC heater systems, assemblies and methods, with the PTC heaters having efficient heating traces for freeze protection applications (e.g., for aircraft/aerospace or the like).

It is noted that apart from their self-regulating properties, the PTC inks can be very advantageous to create heating patterns which provide the uniform power distributions across the surfaces. This can be achieved by developing the patterns using combinations of patches of different/multiple geometries (e.g., square, oval, circular, rectangular, trapezoidal, triangular, etc.).

Typically, PTC ink resistance can be measured as resistance per square area. In this way, the PTC ink resistance gives one the flexibility to design substantially any geometrical patches to cover the given areas. This can also provide various ways of patch nesting within heating areas.

While nesting the patches within the heating area, it can also be important to reach substantially every corner of the heating area, so the power is uniformly distributed and at the same time improves the heating efficiency of the heater.

In example embodiments, the present disclosure provides unique possibilities of heating patch nesting within heating areas for PTC heaters in order to achieve improved and/or efficient heating along with uniform power distribution.

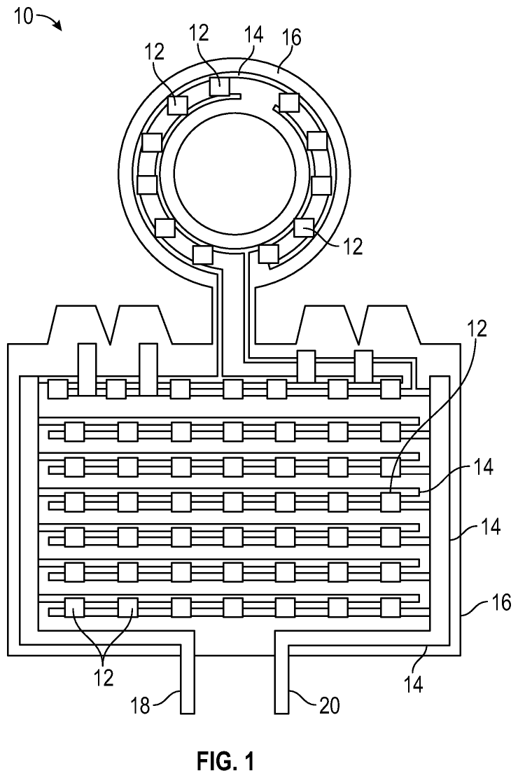

FIG. 1 is a schematic of a positive temperature coefficient (PTC) heater assembly 10. In general, FIG. 1 shows PTC heater assembly 10 having a heating pattern with typical square and rectangular shaped PTC ink patches 12, the plurality of the PTC ink patches 12 being printed from PTC ink on a base substrate 16 (e.g., a thin, flexible substrate 16 with a polymer base). The PTC heater assembly 10 also includes a conducting/conductive trace 14 disposed on the base substrate 16, the conducting trace 14 in communication with the patches 12. Trace 14 includes line 18 and return 20.

As shown in FIG. 1, the heating pattern of the PTC ink patches 12 of the PTC heater assembly 10 can be developed by connecting each pattern in parallel. This means each patch 12 can work or operate as a mini-heater, and these mini heaters (e.g., patches 12) all together can provide enough power to satisfy a requirement. This is being followed as it is noted that the PTC ink is favorable to print substantially any such patches 12, and if any of the patches 12 fail, the rest of the patches 12 will run normally.

It is noted that the patches 12 can be printed as square or rectangular (two connected square) shapes. This is majorly driven due to the resistance measurement method for PTC ink of a typical resistive ink.

The square/rectangular patches 12 can generally provide uniform power distribution on a “perfect” shaped heating area (e.g., square-shaped heating area; stepped square-shaped heating area, etc.).

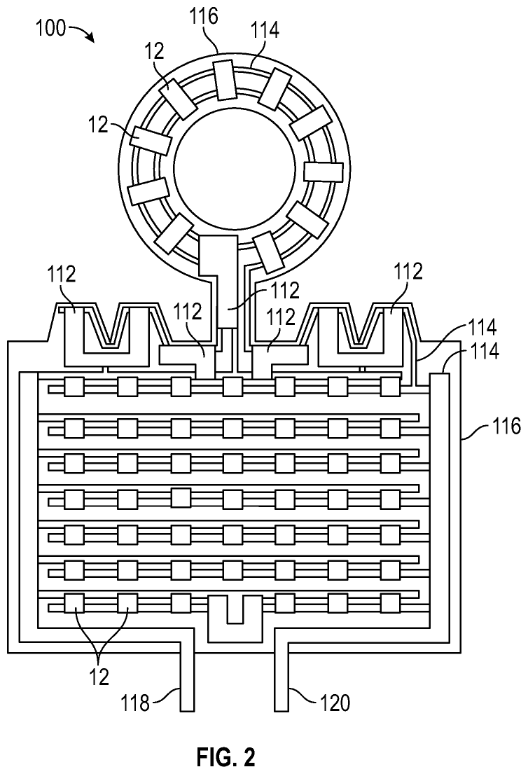

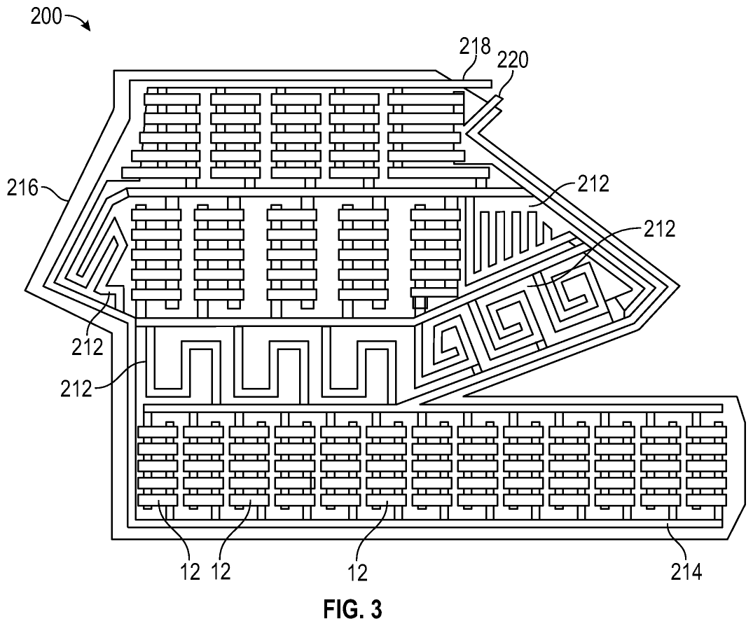

However, when it comes to heating areas with complex shapes, it is not always that a perfect shaped heating area can be obtained for printing the heating patches 12. As such and as discussed further below in conjunction with FIGS. 2 and 3, this kind of application can be handled with by providing different shaped heating patches 112 as well, when a perfect shaped heating area cannot be obtained for printing the heating patches 112 (see FIGS. 2 and 3—e.g., L-shaped, S-shaped, V-shaped, Z-shaped, U-shaped, C-shaped, M-shaped, N-shaped, oval, circular, curved, triangular-shaped, trapezoidal-shaped, parallel-pillar-shaped arrangement, trapezoidal-shaped with loop arrangement, square-shaped with loop arrangement, S-shaped loop arrangement, random-shape arrangement, tapered shapes, etc. of heating patches 112, and also some square or rectangular shaped patches 12, if desired). In this situation when a perfect shaped heating area cannot be obtained for printing heating patches 12, it is noted that a general way for printing just or only square or rectangular patches 12 may not provide efficient heating across the part to be heated.

As such, only having square and/or rectangular-shaped patches 12 may not be suitable for irregular shaped heating areas (e.g., a section of the component surface will be left unheated which reduces the heating efficiency). This can provide for the need of improving the heater assembly 10 efficiency (e.g., in terms of the right amount of power at the right location or locations).

FIG. 2 is a schematic of another positive temperature coefficient (PTC) heater assembly 100 for the present disclosure.

In general, heater assembly 100 has a heating pattern with at least one PTC ink patch 112 (e.g., non-square-shaped or non-rectangular-shaped patch 112) printed from PTC ink on a base substrate 116 (e.g., a thin, flexible substrate 116 with a polymer base). In some embodiments, assembly 100 can also include at least one printed patch 12 that is square or rectangular shaped. In an example embodiment and as shown in FIG. 2, assembly 100 includes a plurality of patches 112 (e.g., two or more PTC ink patches 112 that are non-square-shaped or non-rectangular-shaped), and includes a plurality of patches 12 (e.g., square and/or rectangular-shaped patches 12).

Assembly 100 also includes a conductive trace 114 disposed on the base substrate 116, the conductive trace in communication with the plurality of PTC ink patches 12, 112. Trace 114 includes line 118 and return 120.

As noted, the at least one PTC ink patch 112 is non-square-shaped or non-rectangular-shaped (e.g., L-shaped, S-shaped, V-shaped, Z-shaped, U-shaped, C-shaped, M-shaped, N-shaped, oval-shaped, circular-shaped, curved-shaped, triangular-shaped, trapezoidal-shaped, parallel-pillar-shaped arrangement, trapezoidal-shaped with loop arrangement, square-shaped with loop arrangement, S-shaped loop arrangement, random-shape arrangement and tapered-shaped, etc.).

As such, the present disclosure provides PTC heater assembly 100 with a unique heater and/or heating pattern. For example and without limitation, the heating pattern of patches 12, 112 of heater assembly 100 can be a combination/variety of square, oval, circular, rectangular, trapezoidal, triangular-shaped, etc. patches 12, 112. The combination/variety of PTC ink printing patterns of patches 12, 112 can ensure that substantially each corner or the like of the heating area is printed with heater ink (PTC ink), and thus the heater assembly 100 efficiency is improved.

Considering the overall heating area of assembly 100, the patches 12, 112 can be distributed so that uniform power distribution of assembly 100 can be achieved. At the same time, the places/locations where a typical single square or rectangular patches 12 will not cover the area, then different combinations/varieties of these patches 12, 112 (e.g., square, oval, circular, rectangular, trapezoidal, triangular-shaped, etc., patches 12, 112) can be used for assembly 100.

The patches 12, 112 can be used in combination to arrive at different shapes (e.g., curved-shaped, “L” shaped, “S” shaped, “V” shaped, “Z” shaped patches 112, etc.). Each patch geometry/shape 112 is not limited to the noted designs/shapes, and it is noted that many combinations can be designed and printed on the substrates 116. FIG. 2 shows the result of different combinations/varieties of patches 12, 112, and this example in general is a relatively simple geometry/design. It is noted that FIG. 2 shows example options, however and as noted above, various geometries/designs (e.g., square, oval, circular, rectangular, trapezoidal, triangular-shaped of patches 12, 112) can be used individually and/or in combinations with each other to design an optimal heater patch 12, 112 design of assembly 100 to suit substantially any complex shapes or geometries of the part/area (tanks, pipes, vessels, valves, etc.) or surfaces to be heated.

The resistance of such patches 12, 112 can be calculated as the resistor connected in series or in other words the patches 12, 112 connected in series. This means the overall resistance of such patches 12, 112 can be higher compared to individual patches 12, 112. The effective resistance of such patches 12, 112 can be the sum of resistance of each patch 12, 112 in the combination/design of patches 12, 112 of assembly 100.

Along with PTC ink patches 12, 112 combinations, the routing of the conducting path of trace 114 (line 118 and return 120) to each patch 12, 112 can also be very important. These conducting paths of trace 114 can have the very least or low resistance, hence creating the traces 114 in substantially any shape will not impact significantly.

The combination of patches 12, 112 which results in series connection can also act as an additional controller during heater assembly 100 operation above room temperature along with PTC behavior. This can be achieved due to fast or improved increase of effective resistance of those patch 12, 112 combinations post room temperature which can start reducing the power generation as well.

In general, each PTC ink patch 12, 112 of assembly 100 is configured to operate as a mini-heater. It is noted that PTC heater assembly 100 can be a PTC heater assembly 100 onboard an aircraft or aerospace vessel. Moreover, PTC heater assembly 100 can be a PTC heater assembly 100 for freeze protection applications (for example and without limitation, onboard an aircraft or aerospace vessel).

FIG. 3 is a schematic of another positive temperature coefficient (PTC) heater assembly 200 for the present disclosure.

In general and similar to assembly 100, heater assembly 200 has a heating pattern with at least one PTC ink patch 212 (e.g., non-square-shaped or non-rectangular-shaped patch 212) printed from PTC ink on a base substrate 216 (e.g., a thin, flexible substrate 216 with a polymer base). In some embodiments, assembly 200 can also include at least one printed patch 12 that is square or rectangular shaped. In an example embodiment and as shown in FIG. 3, assembly 200 includes a plurality of patches 212 (e.g., two or more PTC ink patches 212 that are non-square-shaped or non-rectangular-shaped), and includes a plurality of patches 12 (e.g., square and/or rectangular-shaped patches 12).

Assembly 200 also includes a conductive trace 214 disposed on the base substrate 216, the conductive trace 214 in communication with the plurality of PTC ink patches 12, 212. Trace 214 includes line 218 and return 220.

As noted, the at least one PTC ink patch 212 is non-square-shaped or non-rectangular-shaped (e.g., L-shaped, S-shaped, V-shaped, Z-shaped, U-shaped, C-shaped, M-shaped, N-shaped, oval-shaped, circular-shaped, curved-shaped, triangular-shaped, trapezoidal-shaped, parallel-pillar-shaped arrangement, trapezoidal-shaped with loop arrangement, square-shaped with loop arrangement, S-shaped loop arrangement, random-shape arrangement and tapered-shaped, etc.).

As such, the present disclosure provides PTC heater assembly 200 with a unique heater and/or heating pattern. For example and without limitation, the heating pattern of patches 12, 212 of heater assembly 200 can be a combination/variety of square, oval, circular, rectangular, trapezoidal, triangular-shaped, etc. patches 12, 212. The combination/variety of PTC ink printing patterns of patches 12, 212 can ensure that substantially each corner or the like of the heating area is printed with heater ink (PTC ink), and thus the heater assembly 200 efficiency is improved.

Considering the overall heating area of assembly 200, the patches 12, 212 can be distributed so that uniform power distribution of assembly 200 can be achieved. At the same time, the places/locations where a typical single square or rectangular patches 12 will not cover the area, then different combinations/varieties of these patches 12, 212 (e.g., square, oval, circular, rectangular, trapezoidal, triangular-shaped, etc., patches 12, 212) can be used for assembly 200.

The patches 12, 212 can be used in combination to arrive at different shapes (e.g., curved-shaped, “L” shaped, “S” shaped, “V” shaped, “Z” shaped patches 212, etc.). Each patch geometry/shape 212 is not limited to the noted designs/shapes, and it is noted that many combinations can be designed and printed on the substrates 216. FIG. 3 shows the result of different combinations/varieties of patches 12, 212, and this example in general is a relatively simple geometry/design. It is noted that FIG. 3 shows example options, however and as noted above, various geometries/designs (e.g., square, oval, circular, rectangular, trapezoidal, triangular-shaped of patches 12, 212) can be used individually and/or in combinations with each other to design an optimal heater patch 12, 212 design of assembly 200 to suit substantially any complex shapes or geometries of the part/area (tanks, pipes, vessels, valves, etc.) or surfaces to be heated.

The resistance of such patches 12, 212 can be calculated as the resistor connected in series or in other words the patches 12, 212 connected in series. This means the overall resistance of such patches 12, 212 can be higher compared to individual patches 12, 212. The effective resistance of such patches 12, 212 can be the sum of resistance of each patch 12, 212 in the combination/design of patches 12, 212 of assembly 200.

Along with PTC ink patches 12, 212 combinations, the routing of the conducting path of trace 214 (line 218 and return 220) to each patch 12, 212 can also be very important. These conducting paths of trace 214 can have the very least or low resistance, hence creating the traces 214 in substantially any shape will not impact significantly.

The combination of patches 12, 212 which results in series connection can also act as an additional controller during heater assembly 200 operation above room temperature along with PTC behavior. This can be achieved due to fast or improved increase of effective resistance of those patch 12, 212 combinations post room temperature which can start reducing the power generation as well.

In general, each PTC ink patch 12, 212 of assembly 200 is configured to operate as a mini-heater. It is noted that, like assembly 100 discussed above, PTC heater assembly 200 can be a PTC heater assembly 200 onboard an aircraft or aerospace vessel. Moreover, PTC heater assembly 200 can be a PTC heater assembly 200 for freeze protection applications (for example and without limitation, onboard an aircraft or aerospace vessel).

There are many benefits of the systems, assemblies 100, 200 and methods of the present disclosure, including, without limitation: providing highly efficient and effective PTC heater assemblies 100, 200; providing uniform distribution of power across fitting surfaces, uniform temperature distribution, particularly on complex shaped fitting surfaces; providing that substantially any geometrical pattern can be printed to create the effective PTC heater assemblies 100, 200, therefore one can design a heater with improved and/or optimized efficiency for a specified heating surface/area—as such, substantially any complex part which needs to be heated is possible; the combination of patches can also act as an additional controller post room temperature; provides for PTC heater assemblies 100, 200 with unique heating patch combinations for heating space utilization, and effective utilization of heating spaces; the PTC heater assemblies 100, 200 provide efficient power generation and utilization; and/or provide for a reduction in overall product/assembly 100, 200 weight.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

The ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. “Or” means “and/or” unless clearly stated otherwise. Reference throughout the specification to “some embodiments”, “an embodiment”, and so forth, means that a particular element described in connection with the embodiment is included in at least one embodiment described herein, and may or may not be present in other embodiments. In addition, it is to be understood that the described elements may be combined in any suitable manner in the various embodiments. A “combination thereof” is open and includes any combination comprising at least one of the listed components or properties optionally together with a like or equivalent component or property not listed.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Although the systems and methods of the present disclosure have been described with reference to example embodiments thereof, the present disclosure is not limited to such example embodiments and/or implementations. Rather, the systems and methods of the present disclosure are susceptible to many implementations and applications, as will be readily apparent to persons skilled in the art from the disclosure hereof. The present disclosure expressly encompasses such modifications, enhancements and/or variations of the disclosed embodiments. Since many changes could be made in the above construction and many widely different embodiments of this disclosure could be made without departing from the scope thereof, it is intended that all matter contained in the drawings and specification shall be interpreted as illustrative and not in a limiting sense. Additional modifications, changes, and substitutions are intended in the foregoing disclosure. Accordingly, it is appropriate that the appended claims be construed broadly and in a manner consistent with the scope of the disclosure.

What is claimed is:

1. A positive temperature coefficient (PTC) heater assembly comprising:
a plurality of PTC ink patches printed on a base substrate;
a conductive trace disposed on the base substrate, the conductive trace in communication with the plurality of PTC ink patches; and
wherein the plurality of PTC ink patches includes at least one PTC ink patch that is non-square-shaped or non-rectangular-shaped.

2. The assembly of claim 1, wherein the plurality of PTC ink patches are printed from PTC ink.

3. The assembly of claim 1, wherein the base substrate is a thin and flexible substrate with a polymer base.

4. The assembly of claim 1, wherein the plurality of PTC ink patches includes two or more PTC ink patches that are non-square-shaped or non-rectangular-shaped.

5. The assembly of claim 1, wherein the at least one PTC ink patch that is non-square-shaped or non-rectangular-shaped has a shape selected from the group consisting of L-shaped, S-shaped, V-shaped, Z-shaped, U-shaped, C-shaped, M-shaped, N-shaped, oval-shaped, circular-shaped, curved-shaped, triangular-shaped, trapezoidal-shaped, parallel-pillar-shaped arrangement, trapezoidal-shaped with loop arrangement, square-shaped with loop arrangement, S-shaped loop arrangement, random-shape arrangement and tapered-shaped.

6. The assembly of claim 1, wherein each PTC ink patch of the plurality of PTC ink patches is configured to operate as a mini-heater.

7. The assembly of claim 1, wherein the PTC heater assembly is a PTC heater assembly onboard an aircraft or aerospace vessel.

8. The assembly of claim 1, wherein the PTC heater assembly is a PTC heater assembly for freeze protection applications.

9. The assembly of claim 1, wherein the PTC heater assembly is a PTC heater assembly for a tank, pipe, vessel or a valve.

10. The assembly of claim 1, wherein the conductive trace includes a line and a return.

11. A method for fabricating a positive temperature coefficient (PTC) heater comprising:
printing a plurality of PTC ink patches on a base substrate;
disposing a conductive trace on the base substrate, the conductive trace in communication with the plurality of PTC ink patches; and
wherein the plurality of PTC ink patches includes at least one PTC ink patch that is non-square-shaped or non-rectangular-shaped.

12. The method of claim 11, wherein the plurality of PTC ink patches are printed from PTC ink.

13. The method of claim 11, wherein the base substrate is a thin and flexible substrate with a polymer base.

14. The method of claim 11, wherein the plurality of PTC ink patches includes two or more PTC ink patches that are non-square-shaped or non-rectangular-shaped.

15. The method of claim 11, wherein the at least one PTC ink patch that is non-square-shaped or non-rectangular-shaped has a shape selected from the group consisting of L-shaped, S-shaped, V-shaped, Z-shaped, U-shaped, C-shaped, M-shaped, N-shaped, oval-shaped, circular-shaped, curved-shaped, triangular-shaped, trapezoidal-shaped, parallel-pillar-shaped arrangement, trapezoidal-shaped with loop arrangement, square-shaped with loop arrangement, S-shaped loop arrangement, random-shape arrangement and tapered-shaped.

16. The method of claim 11 further comprising operating each PTC ink patch of the plurality of PTC ink patches as a mini-heater.

17. The method of claim 11 further comprising utilizing the PTC heater assembly onboard an aircraft or aerospace vessel.

18. The method of claim 11 further comprising utilizing the PTC heater assembly for freeze protection applications.

19. The method of claim 11 further comprising utilizing the PTC heater assembly to heat a tank, pipe, vessel or a valve.

20. The method of claim 11, wherein the conductive trace includes a line and a return.
